(19) United States
(12) Patent Application Publication
(10) Pub. No.: US 2019/0082167 A1
(43) Pub. Date: Mar. 14, 2019

(54) ALERT DISPLAY SYSTEM

(71) Applicant: OMRON Corporation, Kyoto-shi (JP)

(72) Inventors: Masayuki SHINOHARA, Nagaokakyo-shi (JP); Yasuhiro TANOUE, Otsu-shi (JP); Yoshihiko TAKAGI, Kyoto-shi (JP); Gouo KURATA, Kawanishi-shi (JP); Norikazu KITAMURA, Osaka-shi (JP)

(73) Assignee: OMRON Corporation, Kyoto-shi (JP)

(21) Appl. No.: 16/008,099

(22) Filed: Jun. 14, 2018

(30) Foreign Application Priority Data
Sep. 14, 2017 (JP) 2017-177030

(51) Int. Cl. H04N 13/302; B60Q 9/00; G02B 27/01; F21V 8/00

(52) U.S. Cl. CPC H04N 13/302; B60Q 9/008; G02B 27/0101; G02B 6/0038; G02B 2027/0141; B60Y 2400/92; B60Y 2400/902; G02B 2027/0134; G02B 6/003

(57) ABSTRACT

An alert display system includes a first stereoscopic image display unit, a second stereoscopic image display unit, and a third stereoscopic image display unit that each stereoscopically display, in response to detection of an object near the vehicle by corner sensors and an approaching vehicle detector, a positional relationship between the object and the vehicle. The positional relationship between the vehicle and the object near the vehicle in the stereoscopic image displayed by each of the first stereoscopic image display unit, the second stereoscopic image display unit, and the third stereoscopic image display unit is the same as an actual positional relationship between the object and the vehicle.

### CROSS REFERENCE TO RELATED APPLICATIONS

This application claims priority from prior Japanese Patent Application No. 2017-177030 filed with the Japan Patent Office on Sep. 14, 2017, the entire contents of which are incorporated herein by reference.

### FIELD

The present disclosure relates to an alert display system for displaying an alert to a driver.

### BACKGROUND

A known alert display system displays an alert to a driver. For example, a system described in Patent Literature 1 displays an image representing a vehicle on a display, and displays an obstacle detected by a distance detector as an image gradually approaching the vehicle image when the obstacle actually approaches the vehicle.

### CITATION LIST

### Patent Literature

Patent Literature 1: Japanese Unexamined Patent Application Publication No. 11-16098 (published on Jan. 22, 1999)

### SUMMARY

### Technical Problem

The system may include multiple displays installed at various positions in a vehicle (e.g., an instrument panel, side mirrors, front pillars, or a rear-view mirror) for displaying alerts to a driver. The displays installed at various positions may each display a bird's-eye view of a vehicle as described in Patent Literature 1. When, for example, the driver is parking the vehicle in a garage while shifting his or her viewpoints in various directions, the driver may lose his or her sense of directions and may fail to determine the direction in which an obstacle appearing on each display is actually located relative to the vehicle.

One or more aspects of the present disclosure are directed to an alert display system that displays alerts at multiple different positions and allows a driver to easily determine the positional relationship between a vehicle and a nearby object by viewing any of the alerts.

### Solution to Problem

In response to the above issue, an alert display system according to one aspect of the present disclosure displays an alert to a driver who is driving a vehicle. The system includes at least two stereoscopic image display units installable at different positions in the vehicle. Each of the at least two stereoscopic image display units displays a stereoscopic image. Each of the at least two stereoscopic image display units stereoscopically displays, in response to detection of an object near the vehicle by a detection unit, a positional relationship between the object and the vehicle. The positional relationship in the stereoscopic image displayed by each of the at least two stereoscopic image display units is the same as an actual positional relationship between the object and the vehicle.

In this system, the positional relationship between the object and the vehicle in the stereoscopic image displayed by each of the at least two stereoscopic image display units is the same as an actual positional relationship between the object and the vehicle. This structure allows a driver D to easily determine the positional relationship between a vehicle C and a nearby object by viewing a stereoscopic image displayed by any of the stereoscopic image display units.

In the system according to the above aspect of the present disclosure, the at least two stereoscopic image display units may display, as the alert to the driver, a plurality of alerts that are different from one another.

This system allows the driver to recognize such different alerts by viewing any of the stereoscopic image display units.

In the system according to the above aspect of the present disclosure, the at least two stereoscopic image display units may each include a light source, and a light guide plate that guides light from the light source and emits the light through an emission surface to form the stereoscopic image in a space using the light emitted from the light guide plate.

In this system, the light guide plate is transparent. The stereoscopic image display units can thus be installed on the vehicle C without degrading the interior appearance (design) of the vehicle C.

### Advantageous Effects

One or more aspects of the present disclosure are directed to an alert display system that displays alerts at multiple different positions and allows a driver to easily determine the positional relationship between a vehicle and a nearby object by viewing any of the alerts.

### BRIEF DESCRIPTION OF THE DRAWINGS

FIG. 1 is a schematic diagram illustrating an alert display system according to a first embodiment of the present disclosure used in one situation.

FIG. 2 is a block diagram illustrating an alert display system.

FIG. 3 is a perspective view illustrating a first stereoscopic image display unit included in an alert display system.

FIG. 4 is a cross-sectional view illustrating a first stereoscopic image display unit.

FIG. 5 is a plan view illustrating a first stereoscopic image display unit.

FIG. 6 is a perspective view illustrating an optical path changer included in a first stereoscopic image display unit.

FIG. 7 is a perspective view illustrating optical path changers showing their arrangement.

FIG. 8 is a perspective view illustrating a first stereoscopic image display unit describing the formation of a stereoscopic image.

FIG. 9 is a diagram illustrating a stereoscopic image formed by a first stereoscopic image display unit, a second stereoscopic image display unit, and a third stereoscopic image display unit in an alert display system.

FIG. 10 is a diagram illustrating a vehicle on which an alert display system according to one embodiment of the present disclosure is installed.

FIG. 11 is a perspective view illustrating a first stereoscopic image display unit according to a modification.

FIG. 12 is a perspective view illustrating a first stereoscopic image display unit according to another modification.

FIG. 13 is a cross-sectional view illustrating a stereoscopic image display unit.

FIG. 14 is a plan view illustrating a first stereoscopic image display unit according to still another modification.

FIG. 15 is a diagram illustrating a stereoscopic image appearing when the emission surface of a light guide plate in a second stereoscopic image display unit has the normal line orthogonal to a direction in which a vehicle travels.

FIG. 16 is a diagram illustrating a stereoscopic image appearing when the emission surface of a light guide plate in a second stereoscopic image display unit has the normal line diagonal to a direction in which a vehicle travels.

### DETAILED DESCRIPTION

### First Embodiment

An embodiment of the present disclosure will be described with reference to the drawings. An alert display system 1 according to an embodiment will be described.

### 1. Example Use

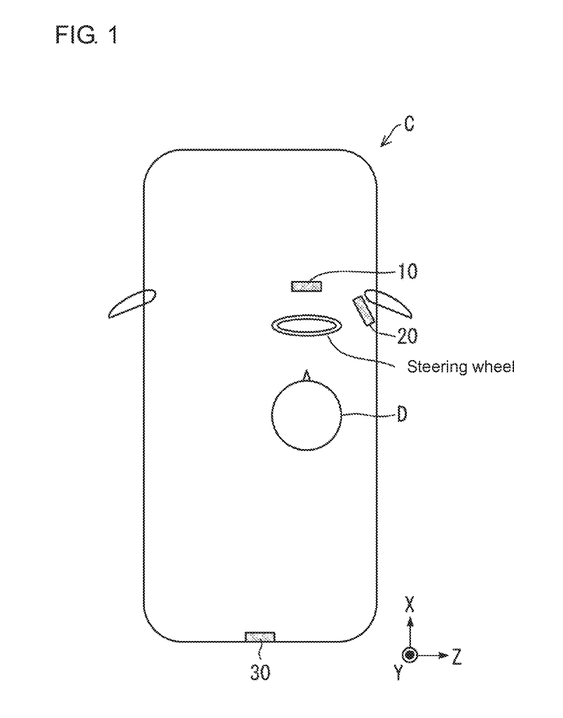

The alert display system 1 used in one situation will be described with reference to FIG. 1. FIG. 1 is a schematic diagram of the alert display system 1 used in one situation. For ease of explanation, the positive X-direction may be referred to as the front or forward direction, the negative X-direction as the rear or rearward direction, the positive Y-direction as the upward direction, the negative Y-direction as the downward direction, the positive Z-direction as the rightward direction, and the negative Z-direction as the leftward direction in FIG. 1.

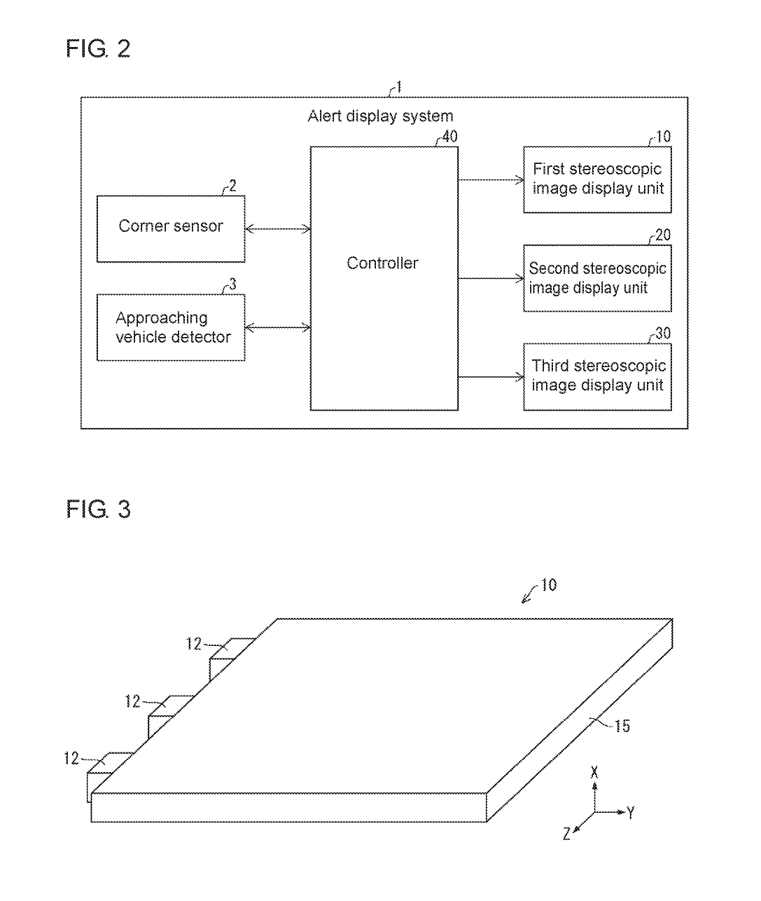

As shown in FIGS. 1 and 2, the alert display system 1 includes corner sensors 2, an approaching vehicle detector 3, a first stereoscopic image display unit 10, a second stereoscopic image display unit 20, and a third stereoscopic image display unit 30. The alert display system 1 displays alerts to a driver D who is driving a vehicle C. The corner sensors 2 and the approaching vehicle detector 3 are examples of a detection unit of the present disclosure. The first stereoscopic image display unit 10, the second stereoscopic image display unit 20, and the third stereoscopic image display unit 30 each display, in response to detection of an object near the vehicle C by the corner sensors 2 and the approaching vehicle detector 3, a stereoscopic image representing the positional relationship between the nearby object and the vehicle C. In the alert display system 1, the positional relationship between the object and the vehicle C in the stereoscopic image displayed by each of the first stereoscopic image display unit 10, the second stereoscopic image display unit 20, and the third stereoscopic image display unit 30 is the same as the actual positional relationship between the object and the vehicle C. This structure allows the driver D to easily determine the positional relationship between the object and the vehicle C.

### 2. Structure

The structure of the alert display system 1 according to one embodiment of the present disclosure will be described with reference to FIGS. 1 and 2. FIG. 2 is a block diagram of the alert display system 1.

The alert display system 1 displays alerts for the driver D of the vehicle C.

FIG. 2 is a block diagram of the alert display system 1. As shown in FIGS. 1 and 2, the alert display system 1 includes the corner sensors 2, the approaching vehicle detector 3, the first stereoscopic image display unit 10, the second stereoscopic image display unit 20, the third stereoscopic image display unit 30, and a controller 40.

The corner sensors 2 are installed at the corners of the vehicle C, which are a left front corner, a right front corner, a left rear corner, and a right rear corner. Each corner sensor 2 detects an object near the vehicle C and determines the distance between the nearby object and the vehicle C. Each corner sensor 2 outputs the determined distance between the vehicle C and the object near the vehicle C to the controller 40, which will be described later.

The approaching vehicle detector 3 is installed on the rear of the vehicle C, and detects another vehicle (object) behind the vehicle C and determines the distance between the other vehicle and the vehicle C. The approaching vehicle detector 3 outputs the determined distance between the vehicle C and the other vehicle behind the vehicle C to the controller 40 (described later).

The first stereoscopic image display unit 10, the second stereoscopic image display unit 20, and the third stereoscopic image display unit 30 display alerts to the driver of the vehicle C. The first stereoscopic image display unit 10 forms a stereoscopic image I1, the second stereoscopic image display unit 20 forms a stereoscopic image I2, and the third stereoscopic image display unit 30 forms a stereoscopic image I3, each in a screenless space. The first, second, and third stereoscopic image display units 10, 20, and 30 have substantially the same structure. The first stereoscopic image display unit 10 will be described herein.

The structure of the first stereoscopic image display unit 10 will now be described with reference to FIGS. 3 to 7.

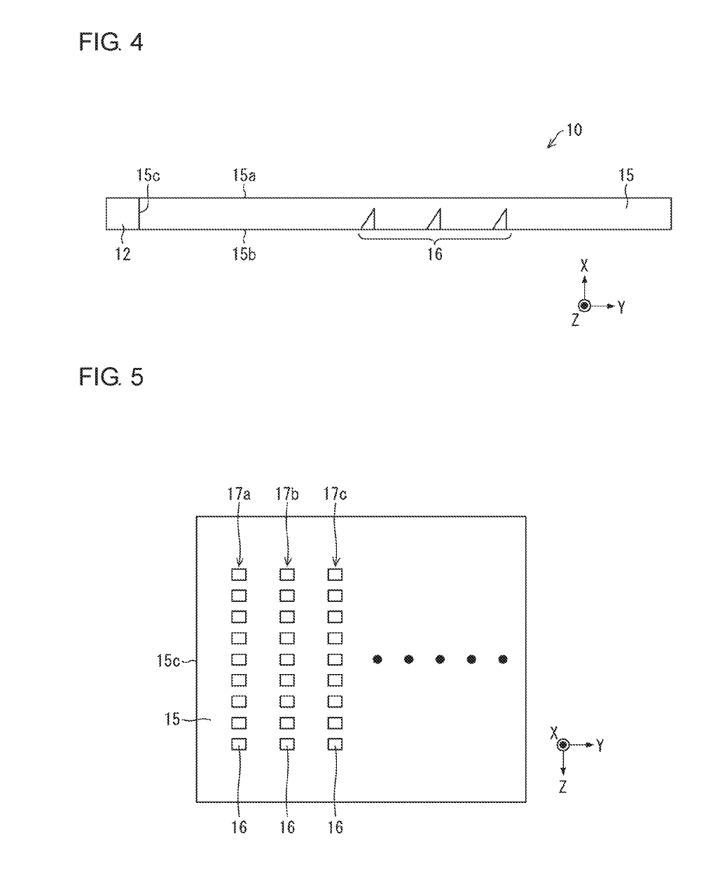

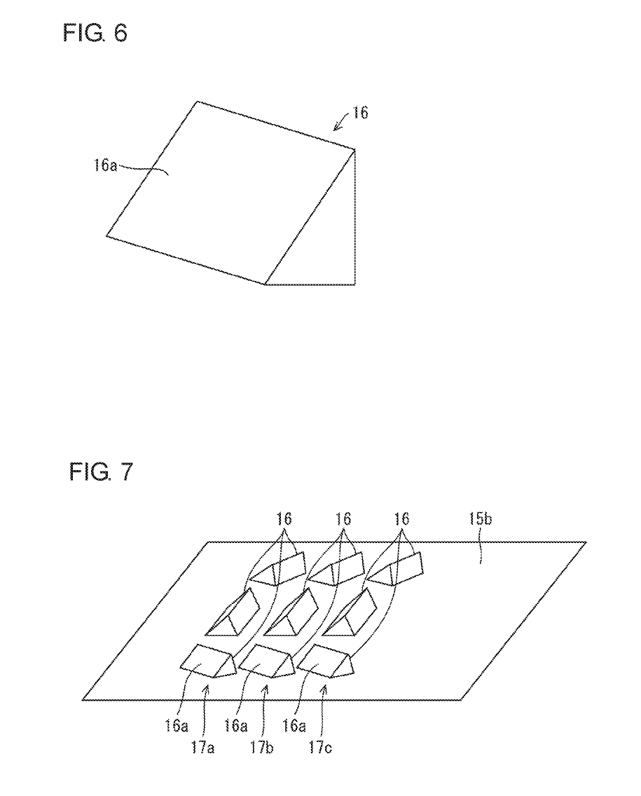

FIG. 3 is a perspective view of the first stereoscopic image display unit 10. FIG. 4 is a cross-sectional view of the first stereoscopic image display unit 10. FIG. 5 is a plan view of the first stereoscopic image display unit 10. FIG. 6 is a perspective view of an optical path changer 16 included in the first stereoscopic image display unit 10.

As shown in FIGS. 3 and 4, the first stereoscopic image display unit 10 includes multiple light sources 12 and the light guide plate 15. To simplify the drawing, FIG. 3 shows three light sources. The light source 12 is, for example, a light-emitting diode (LED).

The light guide plate 15 guides light (incident light) from the light source 12. The light guide plate 15 is formed from a transparent resin material with a relatively high refractive index. The material for the light guide plate 15 may be a polycarbonate resin or a polymethyl methacrylate resin. In an embodiment, the light guide plate 15 is formed from a polymethyl methacrylate resin. As shown in FIG. 4, the light guide plate 15 has an emission surface 15a (light emission surface), a back surface 15b, and an incident surface 15c.

The emission surface 15a emits light guided within the light guide plate 15 and redirected by the optical path changers 16 (described later). The emission surface 15a is a front surface of the light guide plate 15. The back surface 15b is parallel to the emission surface 15a, and has the optical path changers 16 (described later) arranged on it. The incident surface 15c receives light emitted from the light source 12, which then enters the light guide plate 15. The light emitted from the light source 12 enters the light guide plate 15 through the incident surface 15c. The light is then totally reflected by the emission surface 15a or the back surface 15b and guided within the light guide plate 15.

As shown in FIG. 4, the optical path changers 16 are arranged on the back surface 15b and inside the light guide plate 15. The optical path changers 16 redirect the light guided within the light guide plate 15 to be emitted through the emission surface 15a. The multiple optical path changers 16 are arranged on the back surface 15b of the light guide plate 15.

As shown in FIG. 5, the optical path changers 16 are arranged parallel to the incident surface 15c. As shown in FIG. 6, each optical path changer 16 is a triangular pyramid and has a reflective surface 16a that reflects (totally reflects) incident light. The optical path changer 16 may be, for example, a recess on the back surface 15b of the light guide plate 15. The optical path changer 16 may not be a triangular pyramid. As shown in FIG. 5, the light guide plate 15 includes multiple sets of optical path changers 17a, 17b, 17c, and other sets on its back surface 15b. Each set includes multiple optical path changers 16.

FIG. 7 is a perspective view of the optical path changers 16 showing their arrangement. As shown in FIG. 7, the optical path changer sets 17a, 17b, 17c, and other sets each include multiple optical path changers 16 arranged on the back surface 15b of the light guide plate 15 with different reflective surfaces 16a forming different angles with the direction of incident light. This arrangement enables the optical path changer sets 17a, 17b, 17c, and other sets to redirect incident light to be emitted in various directions through the emission surface 15a.

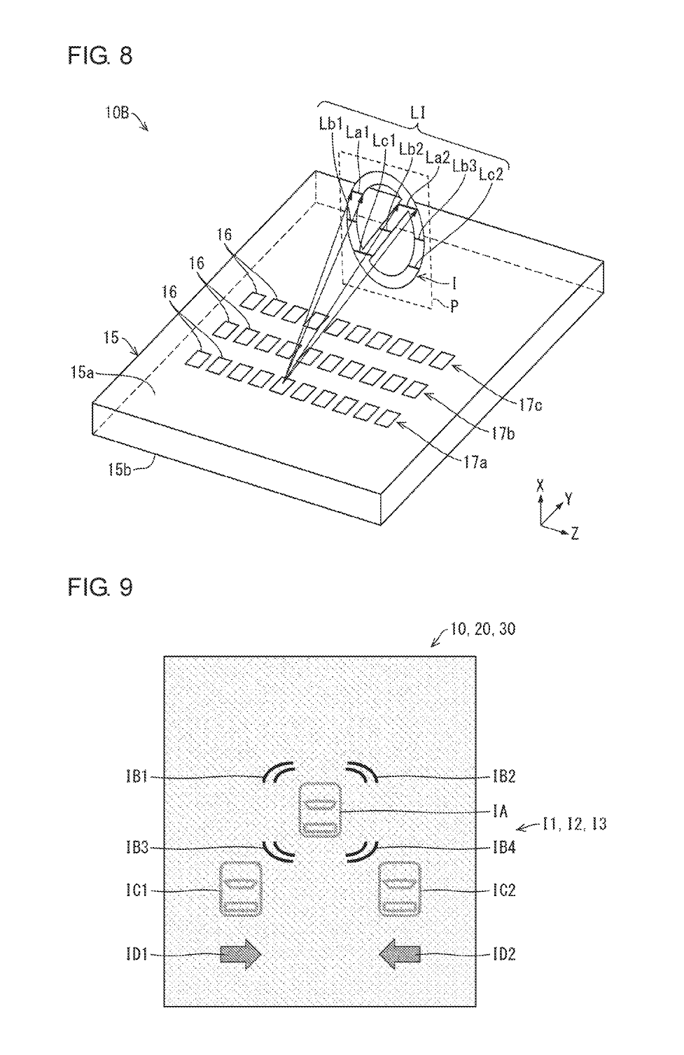

The formation of a stereoscopic image by the first stereoscopic image display unit 10 will now be described with reference to FIG. 8. In an embodiment, light redirected by optical path changers 16 is used to form a stereoscopic image that is a plane image on a stereoscopic imaging plane P perpendicular to the emission surface 15a of the light guide plate 15. In an embodiment, light emitted from the single light source 12 is used to form a stereoscopic image.

FIG. 8 is a perspective view of the first stereoscopic image display unit 10 describing the formation of a stereoscopic image I. In an embodiment, the stereoscopic image I formed on the stereoscopic imaging plane P is a sign of a ring with a diagonal line inside.

In the first stereoscopic image display unit 10, for example, light redirected by each optical path changer 16 in the optical path changer set 17a intersects with the stereoscopic imaging plane P at a line La1 and a line La2 as shown in FIG. 8. The intersections with the stereoscopic imaging plane P form line images LI as part of the stereoscopic image I. The line images LI are parallel to the YZ plane. In this manner, light from the multiple optical path changers 16 included in the optical path changer set 17a forms the line images LI of the line La1 and the line La2. The light forming the images of the line La1 and the line La2 may be provided by at least two of the optical path changers 16 in the optical path changer set 17a.

Similarly, light redirected by each optical path changer 16 in the optical path changer set 17b intersects with the stereoscopic imaging plane P at a line Lb1, a line Lb2, and a line Lb3. The intersections with the stereoscopic imaging plane P form line images LI as part of the stereoscopic image I.

Light redirected by each optical path changer 16 in the optical path changer set 17c intersects with the stereoscopic imaging plane P at a line Lc1 and a line Lc2. The intersections with the stereoscopic imaging plane P form line images LI as part of the stereoscopic image I.

The optical path changer sets 17a, 17b, 17c, and other sets form line images LI at different positions in X-direction. The optical path changer sets 17a, 17b, 17c, and other sets in the first stereoscopic image display unit 10 may be arranged at smaller intervals to form the line images LI at smaller intervals in X-direction. Thus, the first stereoscopic image display unit 10 combines the multiple line images LI formed by the light redirected by the optical path changers 16 in the optical path changer sets 17a, 17b, 17c, and other sets to form the stereoscopic image I that is a substantially plane image on the stereoscopic imaging plane P.

The stereoscopic imaging plane P may be or may not be perpendicular to the X-, Y-, or Z-axis. The stereoscopic imaging plane P may not be flat and may be curved. Thus, the first stereoscopic image display unit 10 may form a stereoscopic image I on any (flat or curved) plane in a space using the optical path changers 16. Multiple plane images may be combined to form a three-dimensional image.

In an embodiment, the stereoscopic image I is a ring mark with a diagonal line. In some embodiments, the optical path changers 16 in the optical path changer sets 17a, 17b, 17c, and other sets may be arranged differently to display any other stereoscopic images.

The first stereoscopic image display unit 10 includes the optical path changers 16 corresponding to the light sources 12. Turning on each light source 12 thus allows the formation of different stereoscopic images.

As shown in FIG. 1, the first stereoscopic image display unit 10 is installed to overlap an instrument panel (not shown), which is located in front of the driver D in the vehicle C. The second stereoscopic image display unit 20 is installed on a front pillar (or may be referred to as an A pillar, not shown) on the right front of the driver D in the vehicle C. The third stereoscopic image display unit 30 is installed on a rear ceiling inside the vehicle C (near a high mounted stop lamp, not shown).

FIG. 9 is a diagram showing the stereoscopic image I1, the stereoscopic image I2, and the stereoscopic image I3 formed by the first stereoscopic image display unit 10, the second stereoscopic image display unit 20, and the third stereoscopic image display unit 30. The first stereoscopic image display unit 10, the second stereoscopic image display unit 20, and the third stereoscopic image display unit 30 in an embodiment separately display the same stereoscopic images I1, I2, and I3. More specifically, when the light sources 12 are turned on, the first stereoscopic image display unit 10, the second stereoscopic image display unit 20, and the third stereoscopic image display unit 30 each display, as the stereoscopic images I1, I2, and I3, (1) a stereoscopic image IA representing the vehicle C, (2) stereoscopic images IB1, IB2, IB3, and IB4 indicating that the distances between the left front corner, the right front corner, the left rear corner, and the right rear corner of the vehicle C and any nearby object (e.g., a wall, another vehicle, or a guardrail) are currently equal to or less than a predetermined distance, (3) stereoscopic images IC1 and IC2 indicating that the distance between the vehicle C and another vehicle traveling in a left or right lane behind the vehicle C is currently equal to or less than a predetermined distance, and (4) stereoscopic images ID1 and ID2 indicating a vehicle passing behind the vehicle C. The controller 40 (described later) turns on and off the light sources 12. In an embodiment, the controller 40 controls the light source 12 associated with the stereoscopic image IA to be constantly on to allow the stereoscopic image IA to appear constantly.

The positional relationship between the vehicle C (specifically, the stereoscopic image IA) and the objects (specifically, the stereoscopic images IB1, IB2, IB3, IB4, IC1, IC2, ID1, and ID2) in the stereoscopic image I1, the stereoscopic image I2, and the stereoscopic image I3 formed by the first stereoscopic image display unit 10, the second stereoscopic image display unit 20, and the third stereoscopic image display unit 30 is the same as the actual positional relationship between the vehicle C and these objects. More specifically, for example, the vehicle C represented by the stereoscopic image IA has the same front-rear direction as the actual vehicle C. The positional relationship between the vehicle C appearing as the stereoscopic image IA and another vehicle appearing as the stereoscopic image IC1 behind the left rear of the vehicle C is the same as the actual positional relationship between the vehicle C and the other vehicle behind the left rear of the vehicle C. The positional relationship between the vehicle C and the objects in the stereoscopic images I1, I2, and I3 may not be completely the same as the actual positional relationship between the vehicle C and the objects, and may have some error (e.g., an error of about 5 degrees).

The controller 40 controls the first stereoscopic image display unit 10, the second stereoscopic image display unit 20, and the third stereoscopic image display unit 30 to display stereoscopic images representing information in accordance with the distances between the vehicle C and nearby objects detected by the corner sensors 2 and the approaching vehicle detector 3. This will be described in detail later.

### 3. Operation Examples

The operation of the alert display system 1 (operation 1, operation 2, and operation 3 described below) will now be described.

### Operation 1

In operation 1 described below, the distance between the right front corner of the vehicle C and a nearby object is less than a predetermined distance (for example, 50 cm or less) when the vehicle C is parked. In this situation, the corner sensor 2 first determines that the distance between the right front corner of the vehicle C and the nearby object is less than the predetermined distance, and outputs the detection result to the controller 40. The controller 40 then detects a possibility of collision between the right front corner of the vehicle C and the nearby object based on the detection result from the corner sensor 2. The controller 40 then controls the first stereoscopic image display unit 10, the second stereoscopic image display unit 20, and the third stereoscopic image display unit 30 to display the stereoscopic image IB2 in each of the stereoscopic images I1, I2, and I3 by turning on the light sources 12 of the first, second, and third stereoscopic image display units 10, 20, and 30. This allows the driver D to notice the possibility of collision between the right front corner of the vehicle C and the nearby object.

### Operation 2

In operation 2 described below, the vehicle C is traveling on a road at a distance less than a predetermined distance (for example, 30 m or less) from another vehicle traveling in a right lane behind the vehicle C. In this situation, the approaching vehicle detector 3 first determines that the distance between the other vehicle behind the right rear of the vehicle C and the vehicle C is less than the predetermined distance (for example, 30 m or less), and outputs the detection result to the controller 40. The controller 40 detects a possibility of collision between the vehicle C and the other vehicle based on the detection result from the approaching vehicle detector 3. The controller 40 controls the first stereoscopic image display unit 10, the second stereoscopic image display unit 20, and the third stereoscopic image display unit 30 to display the stereoscopic image IC2 in each of the stereoscopic images I1, I2, and I3 by turning on the light sources 12 of the stereoscopic image display units 10, 20, and 30. This allows the driver D to notice the possibility of the vehicle C to collide with the other vehicle.

### Operation 3

In operation 3 described below, the vehicle C is being reversed out of a garage at a distance less than a predetermined distance (for example, 3 m or less) from another vehicle approaching the vehicle C from the right rear of the vehicle C. In this situation, the approaching vehicle detector 3 first determines that the distance between the right rear corner of the vehicle C and the other vehicle is less than the predetermined distance, and outputs the detection result to the controller 40. The controller 40 determines that the other vehicle is approaching the vehicle C from the right rear based on the detection result from the approaching vehicle detector 3. The controller 40 then controls the first stereoscopic image display unit 10, the second stereoscopic image display unit 20, and the third stereoscopic image display unit 30 to display the stereoscopic image ID2 in each of the stereoscopic images I1, I2, and I3 by turning on the light sources 12 of the first, second, and third stereoscopic image display units 10, 20, and 30. This allows the driver D to notice the other vehicle approaching the vehicle C from the right rear.

In the alert display system 1 as described above, the first stereoscopic image display unit 10, the second stereoscopic image display unit 20, and the third stereoscopic image display unit 30 form the stereoscopic images I1, I2, and I3 to allow the positional relationship between the vehicle C and objects in the images to be the same as the actual positional relationship between the vehicle C and these objects. In the operations 1 to 3 described above, the driver D can thus easily determine the positional relationship between the vehicle C and the objects by viewing any of the stereoscopic images I1, I2, and I3.

In the alert display system 1, the first stereoscopic image display unit 10, the second stereoscopic image display unit 20, and the third stereoscopic image display unit 30 form the same stereoscopic images I1, I2, and I3, and display multiple alerts. In other words, the first stereoscopic image display unit 10, the second stereoscopic image display unit 20, and the third stereoscopic image display unit 30 display the stereoscopic images IB1, IB2, IB3, IB4, IC1, IC2, ID1, and ID2 as different alerts. This allows the driver to receive all different alerts by viewing any of the stereoscopic images I1, I2, and I3.

A vehicle may incorporate a known system that uses multiple cameras to display a bird's-eye view of a vehicle and the surrounding of the vehicle, which is known as the Around View Monitor (registered trademark). However, the driver of the vehicle may not view the bird's-eye view while reversing the vehicle. Further, the driver checks the surrounding of the vehicle directly although the above system is used. The traditional vehicle with no display in the rear for the driver cannot display the surrounding detected by a corner sensor for the driver. The driver, who is reversing the vehicle while directly viewing the rear of the vehicle, cannot notice the surrounding detected by the corner sensor. Although an alert sound may be used to notify the surrounding situation detected by a corner sensor, the driver provided with the alert sound may be unable to identify which part of the vehicle is about to collide with a nearby object. Although a voice message may follow the alert sound to notify which part of the vehicle is about to collide with the nearby object, the driver may reverse the vehicle and collide with the nearby object during the time lag between the alert sound and the voice message.

In response to this, the alert display system 1 according to an embodiment includes the third stereoscopic image display unit 30 installed on the rear ceiling inside the vehicle C as described above. In the alert display system 1, the third stereoscopic image display unit 30 displays the stereoscopic image I3 including the stereoscopic image IB1, the stereoscopic image IB2, the stereoscopic image IB3, and the stereoscopic image IB4, each indicating that the distance between the vehicle C and any nearby object is currently equal to or less than a predetermined distance. This allows the driver D to check for a danger detected by the corner sensor 2 by viewing the stereoscopic image I3 while reversing the vehicle C by directly viewing the rear of the vehicle C.

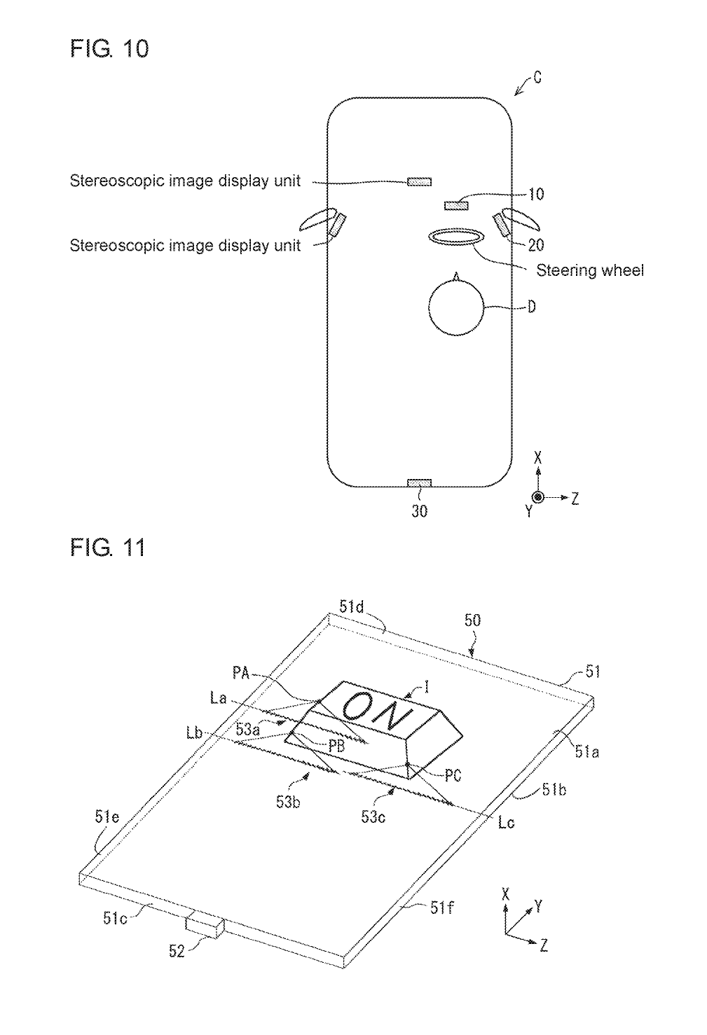

Although the alert display system according to an embodiment includes the first stereoscopic image display unit 10, the second stereoscopic image display unit 20, and the third stereoscopic image display unit 30, the alert display system according to the present disclosure is not limited to this structure. An alert display system according to an embodiment of the present disclosure may include at least two stereoscopic image display units. For example, the alert display system may include only a first stereoscopic image display unit 10 and a second stereoscopic image display unit 20. An alert display system according to another embodiment of the present disclosure may include an additional stereoscopic image display unit arranged at any position other than a first stereoscopic image display unit 10, a second stereoscopic image display unit 20, and a third stereoscopic image display unit 30. FIG. 10 is a diagram showing a vehicle C on which an alert display system according to one embodiment of the present disclosure is installed. As shown in FIG. 10, the alert display system according to an embodiment of the present disclosure may include the additional stereoscopic image display unit installed to overlap a rear-view mirror or a screen of a car navigation system included in the vehicle C, or may be installed on a front pillar on the left front of the driver D.

An alert display system according to another embodiment of the present disclosure may display the vehicle C and objects in the stereoscopic images I1, I2, and I3, which are formed by the first stereoscopic image display unit 10, the second stereoscopic image display unit 20, and the third stereoscopic image display unit 30, to represent the same positional relationship as the actual positional relationship between the vehicle C and the objects. The first stereoscopic image display unit 10, the second stereoscopic image display unit 20, and the third stereoscopic image display unit 30 may form the stereoscopic images I1, I2, and I3 that differ from one another. For example, the first stereoscopic image display unit 10 may display the stereoscopic images IB1, IB2, IB3, IB4, IC1, and IC2 as the stereoscopic image I1, the second stereoscopic image display unit 20 may display the stereoscopic images IC1 and IC2 as the stereoscopic image I2, and the third stereoscopic image display unit 30 may display the stereoscopic images ID1 and ID2 as the stereoscopic image I3.

The light guide plate 15, which is included in each of the first stereoscopic image display unit 10, the second stereoscopic image display unit 20, and the third stereoscopic image display unit 30, is a transparent member. The first stereoscopic image display unit 10, the second stereoscopic image display unit 20, and the third stereoscopic image display unit 30 can thus be installed inside the vehicle C without degrading the appearance (design) of the vehicle C.

An alert display system according to still another embodiment of the present disclosure may include a stereoscopic image display unit that yields a stereoscopic image through parallax fusion using light emitted through a transparent light guide plate, as the first stereoscopic image display unit 10, the second stereoscopic image display unit 20, or the third stereoscopic image display unit 30.

Although each of the first stereoscopic image display unit 10, the second stereoscopic image display unit 20, and the third stereoscopic image display unit 30 in the alert display system according to an embodiment includes the single light guide plate 15 and the multiple light sources 12 to display multiple alerts, the alert display system of the present disclosure is not limited to this structure. An alert display system according to still another embodiment of the present disclosure may include a first stereoscopic image display unit 10, a second stereoscopic image display unit 20, and a third stereoscopic image display unit 30 each including a single light guide plate 15 and a single light source 12 to display a single alert. The first stereoscopic image display unit 10, the second stereoscopic image display unit 20, and the third stereoscopic image display unit 30 may overlap one another to display multiple alerts.

### 4. Modifications

The embodiments of the present disclosure described in detail above are mere examples of the present disclosure in all respects. The embodiments may be variously modified or altered without departing from the scope of the present disclosure. For example, the embodiments may be modified in the following forms. Hereafter, the components that are the same as those in the above embodiments are given the same numerals, and the operations that are the same as those in the above embodiments will not be described. The modifications described below may be combined as appropriate. 4.1

The first stereoscopic image display unit 10, the second stereoscopic image display unit 20, and the third stereoscopic image display unit 30 in the alert display system according to the present disclosure may have the structure other than the structure described in a first embodiment. In the present modification, a stereoscopic image display unit 50, which is a modification of the first stereoscopic image display unit 10, the second stereoscopic image display unit 20, and the third stereoscopic image display unit 30 according to a first embodiment, will be described.

FIG. 11 is a perspective view of the stereoscopic image display unit 50. In FIG. 11, the stereoscopic image display unit 50 displays a stereoscopic image I, and more specifically, a stereoscopic image I of a button (protruding in the positive X-direction) showing the word ON. As shown in FIG. 11, the stereoscopic image display unit 50 includes a light guide plate 51 and a light source 52.

The light guide plate 51 is rectangular and formed from a transparent resin material with a relatively high refractive index. The material for the light guide plate 51 may be a polycarbonate resin, a polymethyl methacrylate resin, or glass. The light guide plate 51 has an emission surface 51a for emitting light, a back surface 51b opposite to the emission surface 51a, and the four end faces 51c, 51d, 51e, and 51f. The end face 51c is an incident surface that allows light emitted from the light source 52 to enter the light guide plate 51. The end face 51d is opposite to the end face 51c. The end face 51e is opposite to the end face 51f. The light guide plate 51 guides the light from the light source 52 to diverge within a plane parallel to the emission surface 51a. The light source 52 is, for example, an LED.

The light guide plate 51 has multiple optical path changers 53 on the back surface 51b, including an optical path changer 53a, an optical path changer 53b, and an optical path changer 53c. The optical path changers 53 are formed substantially continuously and extend in Z-direction. In other words, the multiple optical path changers 53 are arranged along predetermined lines within a plane parallel to the emission surface 51a. More specifically, as shown in FIG. 11, the optical path changer 53a is arranged along a line La, the optical path changer 53b is arranged along a line Lb, and the optical path changer 53c is arranged along a line Lc. The lines La, Lb, and Lc are substantially parallel to Z-direction. Any optical path changers 53 may be arranged substantially continuously along straight lines parallel to Z-direction.

Each optical path changer 53 receives, across its length in Z-direction, the light emitted from the light source 52 and guided by the light guide plate 51. Each optical path changer 53 substantially converges the light incident at positions across the length of each optical path changer 53 to a fixed point corresponding to each optical path changer 53. FIG. 11 shows the optical path changer 53a, the optical path changer 53b, and the optical path changer 53c selectively from the optical path changers 53, showing the convergence of multiple rays of light reflected by the optical path changer 53a, the optical path changer 53b, and the optical path changer 53c.

More specifically, the optical path changer 53a corresponds to a fixed point PA on the stereoscopic image I. Light received at positions across the length of the optical path changer 53a converges at the fixed point PA. Thus, the wave surface of light from the optical path changer 53a appears to be the wave surface of light emitted from the fixed point PA. The optical path changer 53b corresponds to a fixed point PB on the stereoscopic image I. Light received at positions across the length of the optical path changer 53b converges at the fixed point PB. In this manner, light received at positions across the length of an optical path changer 53 substantially converges at a fixed point corresponding to the optical path changer 53. Any optical path changer 53 thus provides the wave surface of light that appears to be emitted from the corresponding fixed point. Different optical path changers 53 correspond to different fixed points. The set of multiple fixed points corresponding to the optical path changers 53 forms a stereoscopic image I recognizable to the driver D in a space (more specifically, in a space above the emission surface 51a of the light guide plate 51).

An alert display system according to a modification of the present disclosure may include a stereoscopic image display unit 50 described in the present modification in place of the first, second, and third stereoscopic image display units 10, 20, and 30 according to a first embodiment. 4.2

In this modification, a stereoscopic image display unit 80, which is another modification of the first, second, and third stereoscopic image display units 10, 20, and 30 according to a first embodiment, will be described.

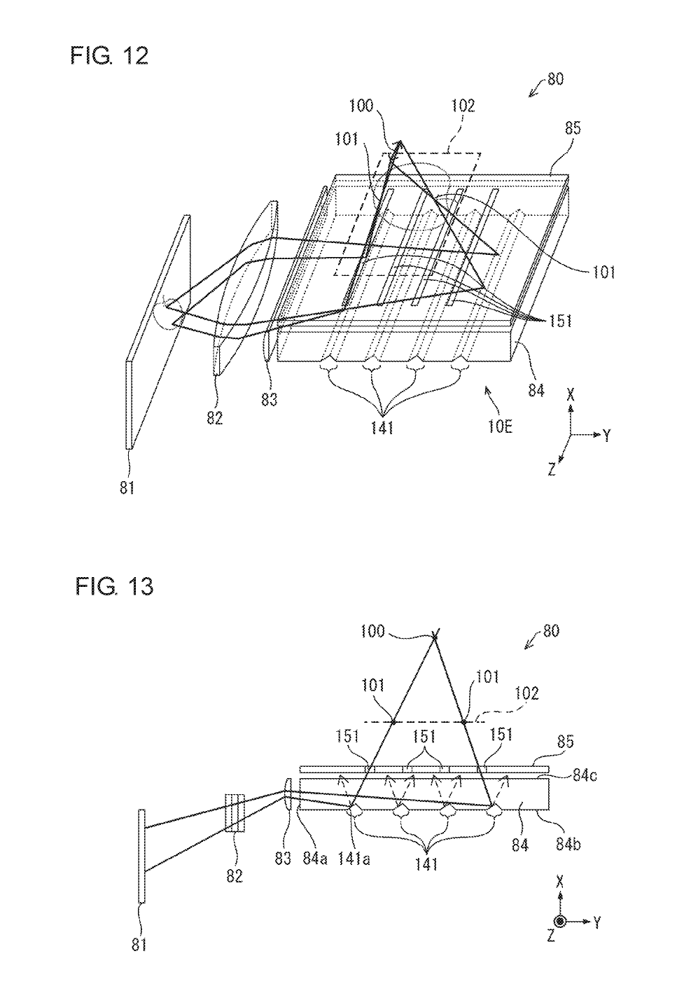

FIG. 12 is a perspective view of the stereoscopic image display unit 80. FIG. 13 is a cross-sectional view of the stereoscopic image display unit 80 showing its structure.

As shown in FIGS. 12 and 13, the stereoscopic image display unit 80 includes an image display 81, an imaging lens 82, a collimator lens 83, a light guide plate 84, and a mask 85. The image display 81, the imaging lens 82, the collimator lens 83, and the light guide plate 84 are arranged in this order along Y-axis. The light guide plate 84 and the mask 85 are arranged in this order along X-axis.

The image display 81 displays, in its display area, a two-dimensional image that is projected in the air by the stereoscopic image display unit 80 in response to an image signal from a controller (not shown). The image display 81 may be a common liquid crystal display that can output image light by displaying an image in the display area. In the illustrated example, the light guide plate 84 has an incident surface 84a facing the display area of the image display 81. The display area and the incident surface 84a are arranged parallel to the XZ plane. The light guide plate 84 has a back surface 84b on which prisms 141 (described later) are arranged and an emission surface 84c (light emission surface) for emitting light to the mask 85. The back surface 84b and the emission surface 84c are opposite to each other and parallel to the YZ plane. The mask 85 has a surface with slits 151 (described later), which is also parallel to the YZ plane. The display area of the image display 81 and the incident surface 84a of the light guide plate 84 may face each other, or the display area of the image display 81 may be inclined to the incident surface 84a.

The imaging lens 82 is located between the image display 81 and the incident surface 84a. The imaging lens 82 converges the image light output in the display area of the image display 81 in the YZ plane parallel to the length of the incident surface 84a, and emits the converged light to the collimator lens 83. The imaging lens 82 may be any lens that can converge the image light. For example, the imaging lens 82 may be a bulk lens, a Fresnel lens, or a diffraction lens. The imaging lens 82 may also be a combination of lenses arranged along Z-axis.

The collimator lens 83 is located between the image display 81 and the incident surface 84a. The collimator lens 83 collimates the image light converged by the imaging lens 82 in the XY plane orthogonal to the length of the incident surface 84a. The collimator lens 83 emits the collimated image light to the incident surface 84a of the light guide plate 84. The collimator lens 83 may also be a bulk lens or a Fresnel lens like the imaging lens 82. The imaging lens 82 and the collimator lens 83 may be arranged in the reverse order. The functions of the imaging lens 82 and the collimator lens 83 may be implemented by one lens or a combination of multiple lenses. More specifically, the imaging lens 82 and the collimator lens 83 may be any combination that can converge, in the YZ plane, the image light output by the image display 81 from the display area and collimate the image light in the XY plane.

The light guide plate 84 is a transparent member, and its incident surface 84a receives the image light collimated in the collimator lens 83, and its emission surface 84c emits the light. In the illustrated example, the light guide plate 84 is a plate-like rectangular prism, and the incident surface 84a is a surface facing the collimator lens 83 and parallel to the XZ plane. The back surface 84b is a surface parallel to the YZ plane and located in the negative X-direction, whereas the emission surface 84c is a surface parallel to the YZ plane and opposite to the back surface 84b. The light guide plate 84 includes the multiple prisms (optical path changers) 141.

The multiple prisms 141 reflect the image light incident through the incident surface 84a of the light guide plate 84. The prisms 141 are arranged on the back surface 84b of the light guide plate 84 and protrude from the back surface 84b toward the emission surface 84c. For the image light traveling in Y-direction, the prisms 141 are, for example, substantially triangular grooves arranged at predetermined intervals (e.g., 1 mm) in Y-direction and having a predetermined width (e.g., 10 μm) in Y-direction. Each prism 141 has optical faces, with its face nearer the incident surface 84a in the image light guided direction (positive Y-direction) being a reflective surface 141a. In the illustrated example, the prisms 141 are formed in the back surface 84b parallel to Z-axis. The image light incident through the incident surface 84a and traveling in Y-direction is reflected by the reflective surfaces 141a of the multiple prisms 141 formed parallel to Z-axis orthogonal to Y-axis. The display area of the image display 81 emits image light from positions different in X-direction orthogonal to the length of the incident surface 84a, and each of the prisms 141 causes the image light to travel toward a predetermined viewpoint 100 from the emission surface 84c of the light guide plate 84. The reflective surface 141a will be described in detail later.

The mask 85 is formed from a material opaque to visible light, and has multiple slits 151. The mask 85 allows, selectively from the light emitted through the emission surface 84c of the light guide plate 84, passage of light traveling toward imaging points 101 in a plane 102 through the slits 151.

The multiple slits 151 allow, selectively from the light emitted through the emission surface 84c of the light guide plate 84, passage of the light traveling toward the imaging points 101 in the plane 102 through the slits 151. In the illustrated example, the slits 151 extend parallel to Z-axis. Each slit 151 corresponds to one of the prisms 141.

The stereoscopic image display unit 80 with this structure allows an image appearing on the image display 81 to be formed and projected on the virtual plane 102 external to the stereoscopic image display unit 80. More specifically, the image light is first emitted from the display area of the image display 81, and passes through the imaging lens 82 and the collimator lens 83. The image light then enters the incident surface 84a, which is an end face of the light guide plate 84. The image light incident on the light guide plate 84 travels through the light guide plate 84 and reaches the prisms 141 on the back surface 84b of the light guide plate 84. The image light reaching the prisms 141 is then reflected by the reflective surfaces 141a of the prisms 141. The reflected image light travels in the positive X-direction, and is emitted through the emission surface 84c of the light guide plate 84 parallel to the YZ plane. The image light emitted through the emission surface 84c partially passes through the slits 151 in the mask 85 to form an image at the imaging points 101 on the plane 102. In other words, the image light emitted from individual points in the display area of the image display 81 converges in the YZ plane and is collimated in the XY plane. The resulting image light is projected on the imaging points 101 on the plane 102. The stereoscopic image display unit 80 can perform this processing for all points in the display area to project the image output in the display area of the image display 81 onto the plane 102. As a result, the user can visually identify the image projected in the air when viewing the virtual plane 102 from the viewpoint 100. Although the plane 102 is a virtual plane on which a projected image is formed, a screen may be used to serve as the plane 102 to improve visibility.

In the stereoscopic image display unit 80 according to an embodiment, image light passes through the slits 151 in the mask 85 selectively from the image light emitted through the emission surface 84c to form an image. However, any structure with no mask 85 or no slit 151 may allow image light to form on the imaging points 101 on the virtual plane 102.

For example, the reflective surface of each prism 141 and the back surface 84b may form a larger angle at a larger distance from the incident surface 84a. This structure can allow image light to form on the imaging points 101 on the virtual plane 102. The angle may be set to allow the prism 141 farthest from the incident surface 84a to totally reflect light from the image display 81.

With the above angle setting, light emitted at a position more rearward from the back surface 84b in X-direction in the display area of the image display 81 (in the negative X-direction) toward a predetermined viewpoint is reflected by a prism 141 farther from the incident surface 84a. However, the stereoscopic image display unit may have any other structure that has the correspondence between one position in X-direction in the display area of the image display 81 and one prism 141. Light reflected by a prism 141 farther from the incident surface 84a travels in a direction more inclined toward the incident surface 84a, whereas light reflected by a prism 141 nearer the incident surface 84a travels in a direction more inclined away from the incident surface 84a. Thus, the light from the image display 81 can be emitted toward a particular viewpoint without the mask 85. In Z-direction, the light emitted through the light guide plate 84 is focused on the image projected plane and diffuses as the light travels away from the plane. This causes a parallax in Z-direction, which enables a viewer to view a projected image stereoscopically with both eyes aligned in Z-direction.

This structure does not block light reflected by each prism 141 and traveling to the viewpoint. The viewer can thus view the image appearing on the image display 81 and projected in the air also when moving his or her viewpoint along Y-axis. However, the angle formed by the light beam directed from each prism 141 to the viewpoint and the reflective surface of the prism 141 changes depending on the viewpoint position in Y-direction, and the position of the point on the image display 81 corresponding to the light beam also changes accordingly. In this example, the prisms 141 focus the light from each point on the image display 81 also in Y-direction to a certain degree. Thus, the viewer can also view a stereoscopic image with both eyes aligned along Y-axis.

This structure includes no mask 85 and reduces the loss of light. The stereoscopic image display unit can thus project a brighter image in the air. Without the mask, the stereoscopic image display unit allows the viewer to visually identify both an object (not shown) behind the light guide plate 84 and the projected image. 4.3

In this modification, a stereoscopic image display unit 60 will be described as a modification of the first stereoscopic image display unit 10, the second stereoscopic image display unit 20, and the third stereoscopic image display unit 30 according to a first embodiment.

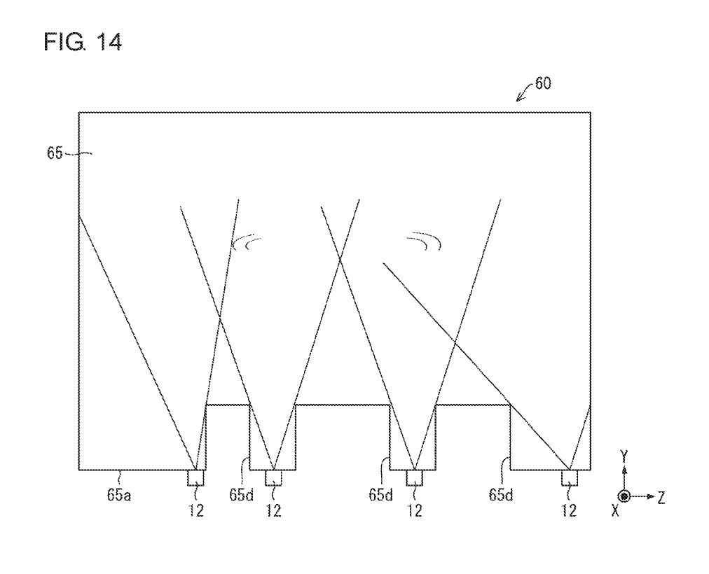

FIG. 14 is a plan view of the stereoscopic image display unit 60. As shown in FIG. 14, the stereoscopic image display unit 60 includes multiple light sources 12 and a light guide plate 65. FIG. 14 shows four light sources 12.

Although the light guide plate 65 has substantially the same structure as the light guide plate 15 described in a first embodiment, the light guide plate 65 has an incident surface 65a with multiple recesses 65d recessed inward (three recesses 65d in the example shown in FIG. 14). The recesses 65d may be processed to absorb light (for example, painted black). The stereoscopic image display unit 60 includes optical path changers corresponding to the light sources 12 to form stereoscopic images, in the same manner as the first stereoscopic image display unit 10 according to a first embodiment.

The stereoscopic image display unit 60 with the above structure absorbs, at the recesses 65d, part of light emitted from the light sources 12 into the light guide plate 65. This structure reduces the divergence of the light from the light sources 12, which enters the light guide plate 65, inside the light guide plate 65, and thus prevents light emitted from each light source 12 from entering optical path changers other than the corresponding optical path changer. As a result, light emitted from one light source 12 is prevented from forming a stereoscopic image not associated with the light source 12 (in other words, a stereoscopic image associated with any other light source 12).

Although the light guide plate 65 in the present modification has the incident surface 65a with the recesses 65d to reduce the divergence of light entering the light guide plate 65 from the light sources 12, the stereoscopic image display units according to the present disclosure are not limited to this structure. In still another modification of the present disclosure, the stereoscopic image display units may reduce the divergence of light entering the light guide plate 65 from the light sources 12 by arranging the light sources 12 in a lens-shaped area.

### 5. Display Examples

Display examples of the alert display system according to the present disclosure will now be described with reference to the drawings. Display examples of stereoscopic images displayed by the second stereoscopic image display unit 20 installed on a front pillar on the right front of the driver D will be described.

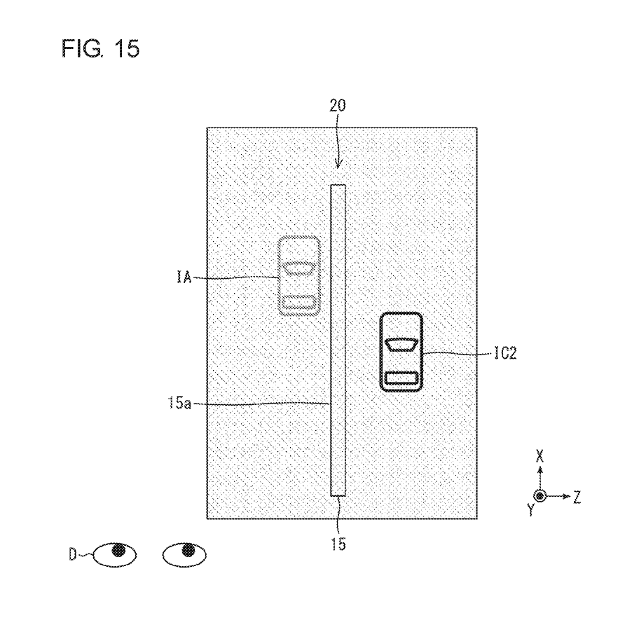

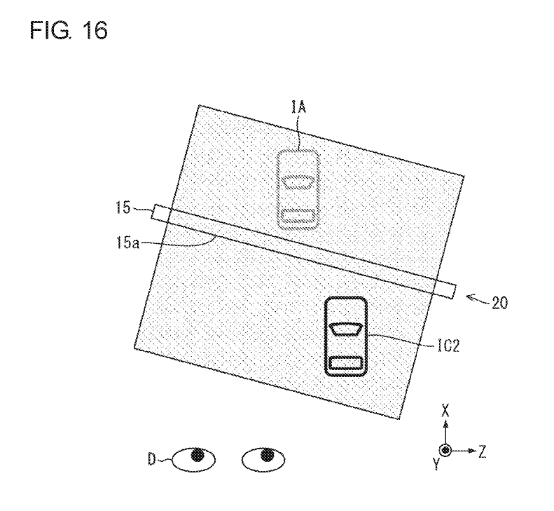

FIG. 15 is a diagram showing a stereoscopic image appearing when the emission surface 15a of the light guide plate 15 in the second stereoscopic image display unit 20 has the normal line orthogonal to a direction in which a vehicle travels (positive X-direction). FIG. 16 is a diagram showing a stereoscopic image appearing when the emission surface 15a of the light guide plate 15 in the second stereoscopic image display unit 20 has the normal line diagonal to a direction in which a vehicle travels (positive X-direction). In these display examples, the second stereoscopic image display unit 20 displays the stereoscopic image IA representing the vehicle C, and the stereoscopic image IC2 representing another vehicle traveling in a right lane behind the vehicle C.

In the alert display system according to the present disclosure, as shown in FIGS. 15 and 16, the direction in which the vehicle travels (positive X-direction) and the normal line of the emission surface 15a of the light guide plate 15, which is included in the second stereoscopic image display unit 20, may intersect with each other at any angle to allow the second stereoscopic image display unit 20 to display the vehicle C (specifically, the stereoscopic image IA) and the other vehicle traveling in a right lane behind the vehicle C (specifically, the stereoscopic image IC2) with the same positional relationship as the actual positional relationship between the vehicle C and the other vehicle. This allows the driver D to easily determine the positional relationship between the vehicle C and the other vehicle.

The embodiments disclosed herein should not be construed to be restrictive, but may be modified within the spirit and scope of the claimed invention. The technical features disclosed in different embodiments may be combined in other embodiments within the technical scope of the invention.

### REFERENCE SIGNS LIST

1 alert display system
2 corner sensor (detection unit)
3 approaching vehicle detector (detection unit)
10 first stereoscopic image display unit (stereoscopic image display unit)
12 light source
15, 65 light guide plate
20 second stereoscopic image display unit (stereoscopic image display unit)
30 third stereoscopic image display unit (stereoscopic image display unit)
50, 60, 80 stereoscopic image display unit
C vehicle
D driver
I1, I1, I2, I3 stereoscopic image

1. An alert display system for displaying an alert to a driver who is driving a vehicle, the system comprising:
at least two stereoscopic image display units installable at different positions in the vehicle, each of the at least two stereoscopic image display units being configured to display a stereoscopic image,
wherein each of the at least two stereoscopic image display units stereoscopically displays, in response to detection of an object near the vehicle by a detection unit, a positional relationship between the object and the vehicle, and
the positional relationship in the stereoscopic image displayed by each of the at least two stereoscopic image display units is the same as an actual positional relationship between the object and the vehicle.

2. The alert display system according to claim 1, wherein
the at least two stereoscopic image display units display, as the alert to the driver, a plurality of alerts that are different from one another.

3. The alert display system according to claim 1, wherein
the at least two stereoscopic image display units each include
a light source, and
a light guide plate configured to guide light from the light source and emit the light through an emission surface to form the stereoscopic image in a space using the light emitted from the light guide plate.

4. The alert display system according to claim 2, wherein
the at least two stereoscopic image display units each include
a light source, and
a light guide plate configured to guide light from the light source and emit the light through an emission surface to form the stereoscopic image in a space using the light emitted from the light guide plate.
